(19) United States
(12) Patent Application Publication
(10) Pub. No.: US 2010/0211508 A1
(43) Pub. Date: Aug. 19, 2010

(54) SYSTEM AND METHOD FOR ENABLING SERVICE TRANSACTIONS

(76) Inventors: Victoria Livschitz, San Ramon, CA (US); Stacey Farias, San Francisco, CA (US); Andriy Miroshnycheuko, Kyiv (UA); Vladimir Tskur, Uzhgorod (UA); Michail Mirzayanov, Saratov (RU); Alexander Rodin, Saratov (RU)

Correspondence Address: DERGOSITS & NOAH LLP, Three Embarcadero Center, Suite 410, SAN FRANCISCO, CA, 94111, US

(21) Appl. No.: 12/681,094

(22) PCT Filed: Oct. 1, 2008
(86) PCT No.: PCT/US08/11385

§ 371 Date: Mar. 31, 2010

Related U.S. Application Data
(60) Provisional application No. 60/997,258, filed on Oct. 1, 2007.

(51) Int. Cl. G06Q 30/00; G06Q 10/00; G06Q 99/00; G06Q 50/00; G06F 17/30

(52) U.S. Cl. 705/80; 705/27; 705/347; 707/802; 707/E17.044; 715/760

(57) ABSTRACT

The present invention provides a computer-based system and method for brokering transactions between sellers and a buyer of goods or services, the system including computer having the requisite software and hardware to provide a database, a provider portal, and a consumer portal. Preferably, the database contains a hierarchical listing of services being offered and options and information associated with them. The provider portal and consumer portal are configured to gather specified information so that a transaction based on the information can be formed.

### CROSS-REFERENCE TO RELATED APPLICATIONS

This application is a continuation-in-part of pending U.S. Provisional Application Ser. No. 60/997,258, filed Oct. 1, 2007, which is hereby incorporated by reference in its entirety.

### FIELD

The present invention relates generally to a system and method for enabling transactions between a service provider and a consumer, and specifically to a computer based online brokerage that allows users to interact in a flexible, platform independent manner.

### BACKGROUND

The term “E-Commerce” has come into common usage to describe the use of the Internet to facilitate the buying and selling of commodities. A number of examples of E-Commerce applications exist, illustrating the potential advantages enabled by the interchange of information of broad networks. However, these prior art systems are primarily configured for the exchange of goods and suffer from various drawbacks.

For example, catalog model E-Commerce applications allow sellers to offer goods to consumers using a format that details their offerings. Buyers browse the items described in an on-line catalog and can place orders for desired goods. Although catalog systems offer a model that is readily understood, they can be difficult and time-consuming for buyers to navigate. Often, only a single seller is represented which minimizes the number of options available to buyers. In systems aggregating a number of sellers, the catalog is generally maintained in specific, often proprietary, forms to allow integration with the catalog applications.

Some of these drawbacks represented by the simple catalog model are overcome by the aggregation of multiple vendors using a search engine to access product offerings. Typically, a third-party provides the search engine functionality and is able to return results matching a buyer's query. However, the success of such systems depends upon the sellers adopting common language to describe the products so that an accurate search can be conducted. Also, these systems typically offer minimal capacity of comparison between the sellers and usually only allow price comparisons.

There are also proprietary networks that directly link providers and consumers. However, such systems inherently require the providers and consumers to adopt a specific platform. This significantly decreases the flexibility of the participants and does not provide a convenient way to accommodate growth to include different types of commodities.

As can be appreciated, none of these prior art systems are optimized for transactions involving services. Further, the prior art systems provide only minimal buyer and seller interaction. Nor do these disclosures address the problems of contract negotiation, formation, or performance.

Accordingly, what has been needed is a system and method for brokering on-line transactions between service providers and consumers. There is also a need facilitating the entry of information associated with offered services and requested services through web browsers. Yet another need is for a system and method for matching potential customers with one or more providers on the basis of one or more criterion. Further, there is a need for a system and method capable of monitoring the performance of an established service contract.

The present invention satisfies these and other needs.

### SUMMARY OF THE INVENTION

In one embodiment, the invention is a method, in a computer system for brokering transactions for services between at least one provider and at least one consumer, for forming a transaction involving a service offered by a provider between a provider and a consumer. The method comprises the steps of comprising the steps of providing a provider portal configured to accept information from the provider specifying characteristics of an offered service, storing the provider information to a database, wherein the database comprises a service catalog having the offered service grouped by at least one characteristic of the offered service, providing a consumer portal configured to accept information from a consumer, displaying the service catalog having the offered service through the consumer portal, and forming a transaction for the offered service upon selection by the consumer, wherein the transaction is based upon the characteristics of the offered service.

Preferably, the offered service is grouped by service category and further grouped by service type. Also preferably, the information from the provider includes at least one associated service item option for configuring the service and the step of storing the provider information further comprises grouping the associated service item by service item type.

In this embodiment, displaying the service catalog preferably further comprises displaying the associated service item option with the offered service and forming a transaction for the offered service occurs upon selection of the associated service item option, wherein the transaction is based upon the characteristics of the offered service and the associated service item option.

In a further embodiment of the invention, the steps of providing a provider portal and providing a consumer portal preferably comprise providing a web browser-based interface that allows providers and consumers to input characteristics associated with the service. Also preferably, the provider portal is configured to prompt the provider with specific options depending upon the offered service. Further, the provider portal can comprise a price program module that prompts the provider for information related to pricing. In this aspect, the information related to pricing is selected from the group consisting of set up fee, periodical fee and metered price.

In another embodiment of the invention, the consumer portal is configured to prompt the consumer for information associated with the offered service. Preferably, the information associated with the offered service is derived from the provider information.

The invention also includes an embodiment wherein the step of storing the provider information comprises translating the provider information into data stored in an extensible markup language. Preferably, the extensible markup language is a Service Definition Language having a plurality of properties, wherein the step of translating provider information comprises assigning a value corresponding to the offered service to at least one of the properties.

In another embodiment of the invention, after forming the transaction, the method further comprises the steps of receiving information from at least one of the consumer and the provider related to the transaction and modifying terms of the transaction based upon the received information. Similarly, the method can include receiving information from at least one of the consumer and the provider related to the transaction and displaying information related to performance of the transaction based upon the received information.

In yet another embodiment of the invention, the method involves forming transactions wherein the offered service is an information technology service. For example, the offered service can include server hosting, storage, and software-as-a-service.

The invention also is directed to a computer readable medium for use in a computer system computer system for brokering transactions for services between a provider and a consumer. In this aspect, the computer readable medium has computer executable instructions for providing a provider portal configured to accept information from the provider specifying characteristics of an offered service, storing the provider information to a database, wherein the database comprises a service catalog having the offered service grouped by at least one characteristic of the offered service, providing a consumer portal configured to accept information from a consumer, displaying the service catalog having the offered service through the consumer portal, and forming a transaction for the offered service upon selection by the consumer, wherein the transaction is based upon the characteristics of the offered service. Preferably, the offered service is grouped by service category and further grouped by service type. Also preferably, the information from the provider includes at least one associated service item option for configuring the service.

In one embodiment of the invention, the instructions for providing a provider portal and providing a consumer portal are configured to provide a web browser-based interface that allows providers and consumers to input characteristics associated with the service.

Further, the instructions for storing the provider information to a database are preferably configured to translate the provider information into an extensible markup language, and more preferably, into the Service Definition Language. In the noted embodiment, the Service Definition Language comprises a plurality of properties and the translation of provider information comprises assigning a value corresponding to the offered service to at least one of the properties.

The invention also includes embodiments directed to a computer system for brokering transactions for services between at least one provider and at least one consumer, wherein the system is capable of forming a transaction for a service offered by a provider between the provider and a customer. In such embodiments, the system comprises a server having a provider portal and a consumer portal in communication with a database storing information related to the offered service, the provider portal receiving information from the provider specifying the characteristics of the offered service, the server storing the offered service in the database, wherein the database comprises a service catalog having the offered service grouped by at least one characteristic of the offered service, the server displaying the service catalog having the offered service through the consumer portal, and the server forming a transaction for the offered service upon selection by the consumer, wherein the transaction is based upon characteristics of the offered service. Preferably, the offered service is grouped by service category and further grouped by service type. Also preferably, the information from the provider includes at least one associated service item option for configuring the service.

In one embodiment of the invention, the provider portal and consumer portal are configured to provide a web browser-based interface that allows providers and consumers to input characteristics associated with the service.

In yet another embodiment of the invention, the server stores the provider information to a database by translating the provider information into an extensible markup language, and more preferably, into the Service Definition Language. In the noted embodiment, the Service Definition Language comprises a plurality of properties and the translation of provider information comprises assigning a value corresponding to the offered service to at least one of the properties.

### BRIEF DESCRIPTION OF THE DRAWINGS

Further features and advantages will become apparent from the following and more particular description of the preferred embodiments of the invention, as illustrated in the accompanying drawing, and in which:

FIG. 1 is a depiction of a GUI associated with entry of general information associated with a service creation module, according to the invention;

FIG. 2 is a depiction of a GUI associated with entry of policies information associated with a service creation module, according to the invention;

FIG. 3 is a depiction of a GUI associated with entry of service type information associated with a service creation module, according to the invention;

FIG. 4 is a depiction of a GUI associated with entry of account profile information associated with a service creation module, according to the invention;

FIG. 5 is a depiction of a GUI associated with entry of structure information associated with a service creation module, according to the invention;

FIG. 6 is a representation of a flow chart that summarizes the steps associated with the creation of a service listing, according to the invention;

FIG. 7 is a depiction of a GUI associated with entry of general information associated with a price program module, according to the invention;

FIG. 8 is a depiction of a GUI associated with entry of modifier information associated with a price program module, according to the invention;

FIG. 9 is a depiction of a GUI associated with entry of target information associated with a price program module, according to the invention;

FIG. 10 is a depiction of a GUI associated with entry of conditions information associated with a price program module, according to the invention;

FIG. 11 is a representation of a flow chart that summarizes the steps associated with the creation of a price program, according to the invention;

FIG. 12 is a depiction of a GUI associated with a service catalog, according to the invention;

FIG. 13 is a depiction of a GUI associated with entry of general information associated with a service order module, according to the invention;

FIG. 14 is a depiction of a GUI associated with entry of account information associated with a service order module, according to the invention;

FIG. 15 is a depiction of a GUI associated with entry of order configuration information associated with a service order module, according to the invention;

FIGS. 16 and 17 are depictions GUIs associated with order configuration, according to the invention;

FIG. 18 is a depiction of a GUI showing a service listing, according to the invention; and

FIG. 19 is a representation of a flow chart that summarizes the steps associated with the creation of a service order, according to the invention.

### DETAILED DESCRIPTION

The invention comprises computer-implemented systems and methods for brokering transactions between sellers and a buyer of goods or services. In a presently preferred embodiment, the system includes a computer having the requisite software and hardware to provide a database, a provider portal, and a consumer portal. The database contains information associated with the services being offered. The provider portal is configured to enable sellers to interactively enter information into the database. The consumer portal is configured to enable the consumer to select and review the descriptive information from the database and to enter information associated with configuring a service order. Together, the database, provider portal and consumer portal generally comprise the automated service broker application of the invention.

As discussed above, interaction with the service broker application platform is preferably accomplished through a provider portal, configured for service providers, and a consumer portal, configured for prospective purchasers of services. The platform operates between the two portals in order to ensure compatibility and maintain a single clearinghouse for all offered services. Using the respective portal, service providers can define the services offered and the obligations expected in return for performance of the services, and service consumers can search for services and receive offered services.

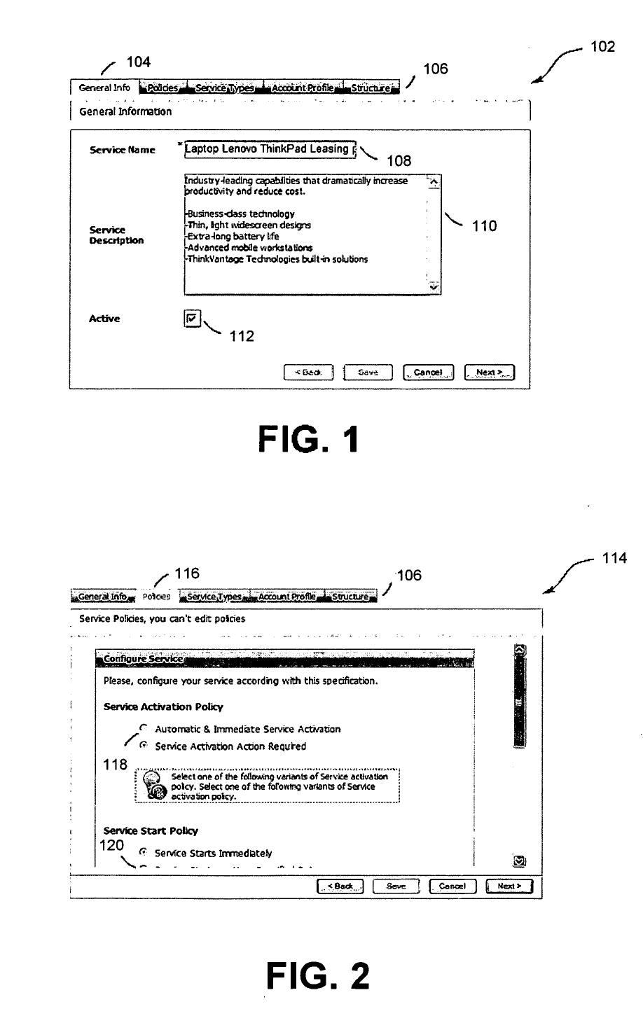

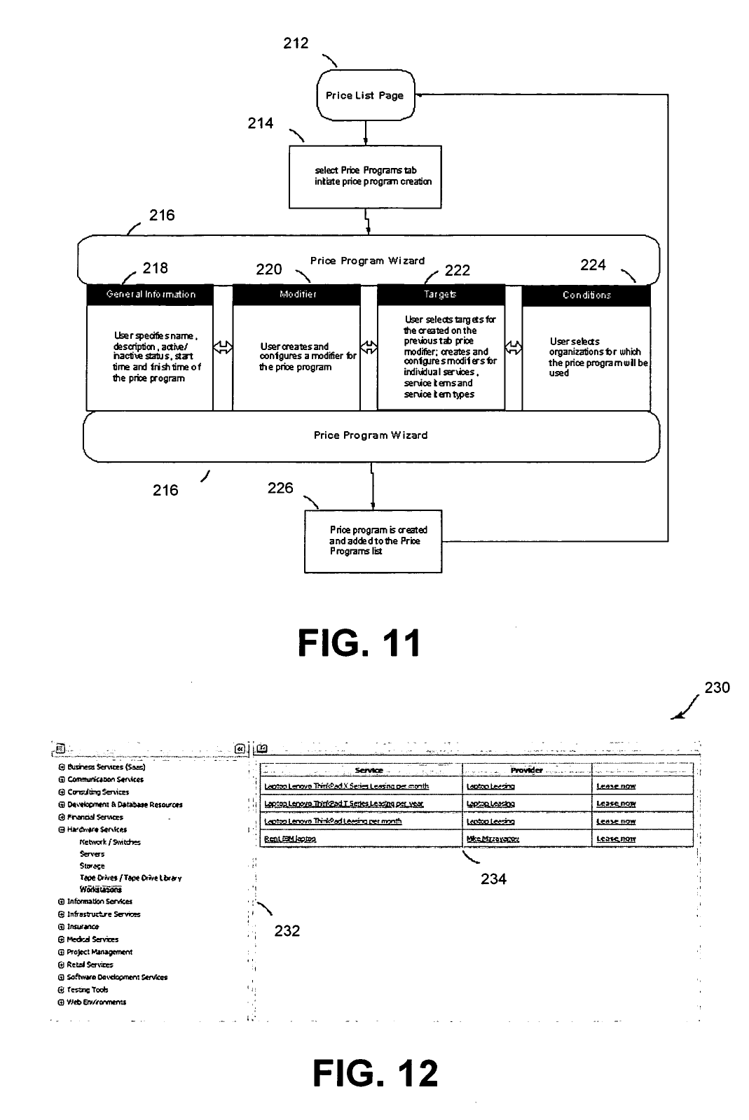

In one embodiment of the invention, the operation of the provider portal is outlined in exemplary graphical user interfaces (GUIs) depicted in FIGS. 1-5 and 7-10 and in the flowcharts illustrated in FIGS. 6 and 11. These operations allow a service provider to interact with the systems and programs of the invention to describe characteristics of the offered service. The relevant characteristics are stored by the system in a database so that the broker application can manage the information and potential consumers of the service can access the information.

Preferably, users employ a suitable web browser to access a main navigation page, also known as the provider portal dashboard, which contains links to the various modules of the broker application platform. As will be appreciated by one of skill in the art, the web browser interface can be configured to present the user with a combination of input text boxes, pull down menus, combo boxes, radio buttons, toggles and the like to facilitate the input of information related to the services.

To create a service listing, a user navigates through a series of provider services pages configured to allow the user to specify characteristics for a service. These pages include the GUIs shown in FIGS. 1-5 and generally comprise the service wizard module of the invention. As shown in FIG. 1, General Information GUI 102 is called when a user selects graphical button 104 on navigation tab bar 106. Text boxes 108 and 110 allow the user to specify a name for the service and a description. Check box 112 allows the user to specify the activity state of the service.

As shown in FIG. 2, Policies GUI 114 is displayed when a user selects graphical button 116. On this screen, the user is guided to input various service options using radio buttons 118 and 120 activation, start, cancellation policies, and the like.

Preferably, services are classified hierarchically within the database of the platform. More preferably, the broadest classification is known as “service category.” The next level of classification is known as “service type.” Thus, within each service category, there can be a number of service types. The most detailed classification is known simply as “service.” Each service represents the smallest unit that can be the subject of a transaction.

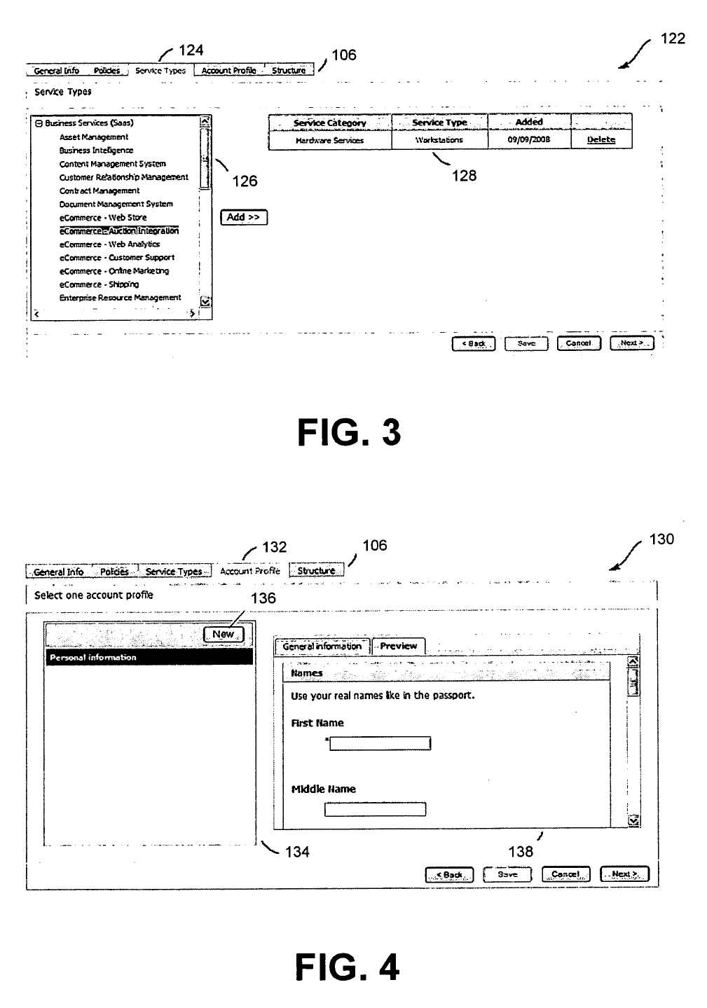

Accordingly, Service Type GUI 122 shown in FIG. 3, allows the user to input the necessary information to group the service into the appropriate classification. GUI 122 is displayed when a user selects graphical button 124. The interface is configured to allow a user to select among service type to classify the service though pull down menu 126. As depicted, pull down menu 126 shows the various service types (Asset Management, Buisiness Intelligence, Content Management System, etc.) associated with the “Busines Services” service category. Box 128 displays information having already been entered by the user. For example, in FIG. 3, box 128 shows the date a service of the service type “Workstations” in the service category of “Hardware Services” was added to the system.

Next, Account Profile GUI 130 shown in FIG. 4, is selected by graphical button 132 and allows a user to enter account profile information. For example, menu 134 allows a user to select a previously entered account. Alternatively, button 136 activates window 138, allowing a user to input information associated with a new account profile.

Preferably, each service recorded in the system can be configured in multiple ways through the specification of “service items.” Generally, service items correspond to options that apply to a given service. Multiple service items sharing a common characteristic can be grouped together into a “service item type.” For example, in a service comprising the lease of a laptop computer, associated service items can include the type of processor, the operating system, the memory and the hard drive capacity. Depending upon the circumstances, a given service can belong to more than one service type or service category.

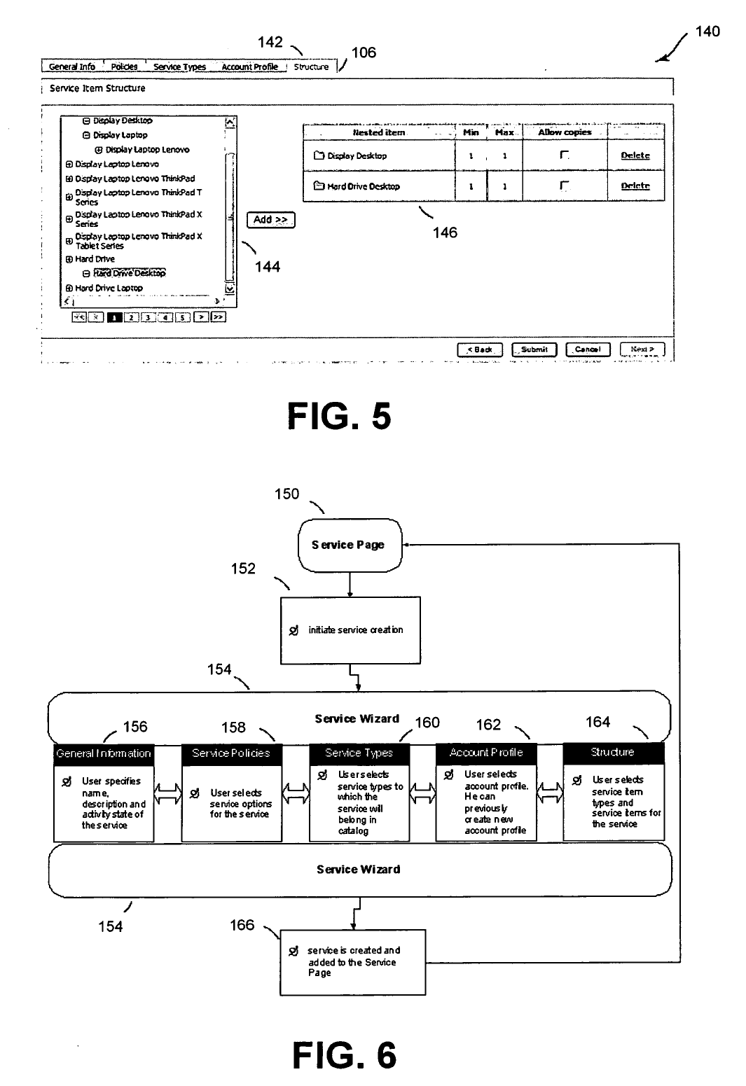

Thus, as shown in FIG. 5, Structure GUI 140 is configured to allow the user to specify service items and service item types associated with the service being entered into the system. GUI 140 is selected by graphical button 142. Pull down menu 144 allows the user to select service items and service item types. Box 146 provides a display to track the information entered and gives options for managing and controlling the classification of the service items. For example, box 146 shows that the service item types “display” and “hard drive” are nested within “desktop.”

The flow chart shown in FIG. 6 summarizes the information gathering process associated with the creation of a service entry discussed above. As indicated, the process starts at step 150 in which a user has called a main service navigation page. This page gives the user an option to create a new service in step 152, which calls the Service Wizard module 154 that prompts the user to input the information necessary to create the new service listing. Service Wizard module 154 comprises sub modules including General Information module 156, corresponding to GUI 104, Policies module 158, corresponding to GUI 114, Service Type module 160, corresponding to GUI 122, Account Profile module 162, corresponding to GUI 132, and Structure module 164, corresponding to GUI 140. As described above, a user navigates between these GUIs using navigation tab bar 106. Following completion of the Service Wizard 154, the new service listing is added to the database in step 166, allowing it to be added to a service list on the provider portal and to a service catalog accessible through the consumer portal. As indicated by the flow chart, once the listing is added to the database and added to the service catalog, the user is returned to the main service navigation page.

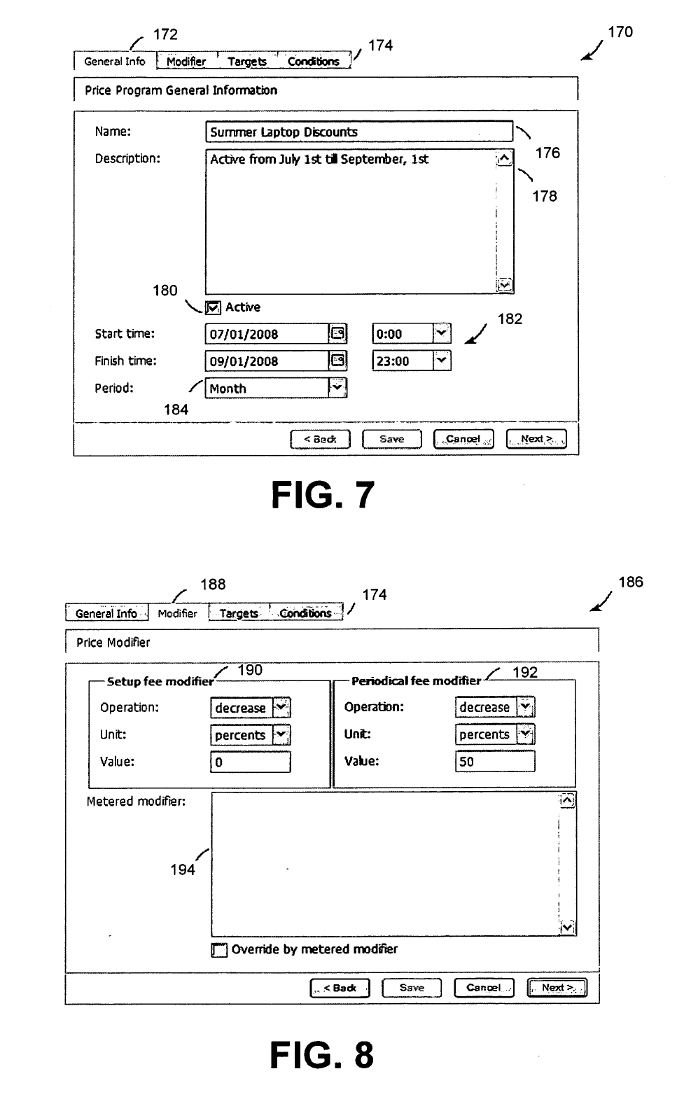

In the noted embodiment, there is preferably a price program creation module to guide the user through steps necessary to specify a price program associated with one or more desired service offerings. Although pricing can be established individually for each service, price program allows a convenient means for applying a given pricing strategy to a number of services or service items automatically. The module can be selected from the main provider navigation menu and allows a user to select among the various screens configured to gather relevant price information. The associated GUIs are shown in FIGS. 7-10 and generally comprise the price program wizard of the invention.

As shown in FIG. 7, a General Info GUI 170 is displayed when graphical button 172 is selected on navigation tab bar 174. Input text boxes 176 and 178 allow a user to specify the name and description of the price program. Check box 180 allows the user to indicate the status of the price program and pull down menu 182 allows the user to establish the start and finish times for the program. Pull down menu 184 selects among period types for which prices can be set, including day, week, month and year. The proper period is preferably defined during creation of the service entity for which this service item is a sub entity.

The Modifier GUI 186 is displayed when graphical button 188 is selected as shown in FIG. 8. This screen prompts the user to create and configure an ordered threesome for the service item, including the setup fee in box 190, the periodical fee in box 192 and the metered price 194. Preferably, the modifications available for the setup fee and periodical fee include adding or subtracting a fixed amount, adding or subtracting a percent of the price, or setting the price to a specific amount. For example, selection +$1 and −5%, respectively, means that the setup fee will be increased by 1 USD and the periodical fee will be decreased by 5 percent. Metered price modifications preferably include an override, so that the metered modifier will override the metered price and concatenating, so that the metered price and the metered modifier will be concatenated.

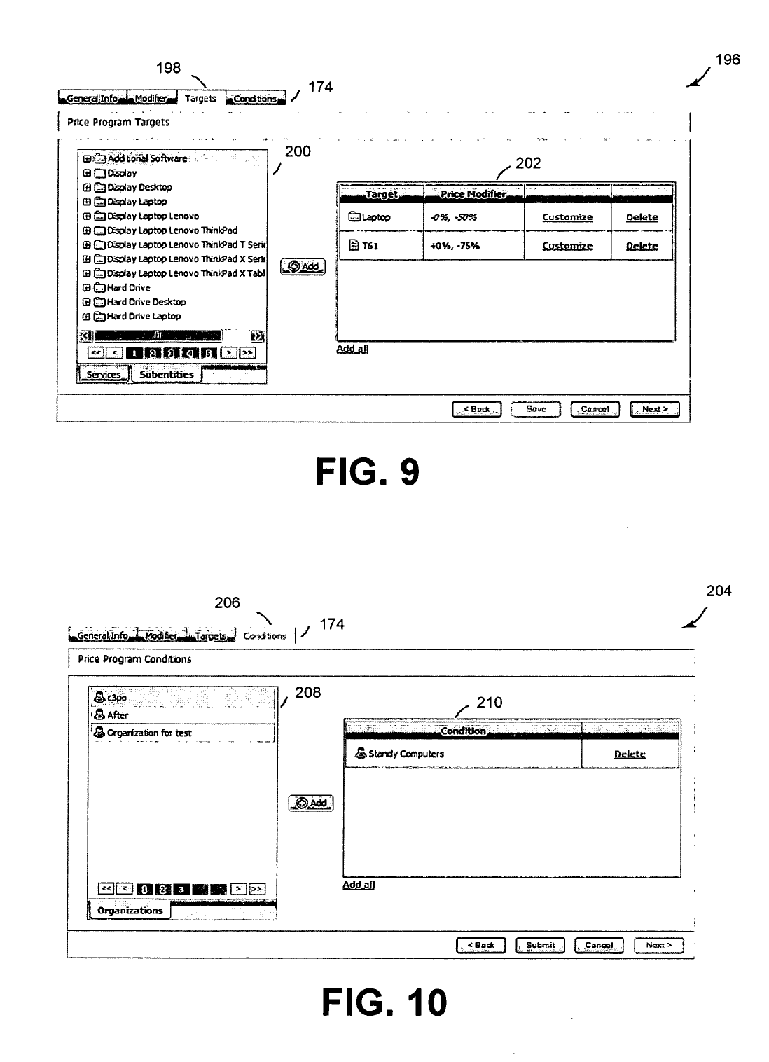

Next, as shown in FIG. 9, the Targets GUI 196 is selected via graphical button 198. This screen guides the user through selection of targets to which the price program will apply. Menu 200 allows the user to specify the target and box 202 displays the price programs that have been associated with selected targets. Suitable targets include a service item, a service type, a service, a service category, and combinations thereof.

In operation, a service item target will result in the specified price modifier being applied to an individual service item. Choosing a service type target results in the related price modifier being applied to all service items belonging to the specified service item type or its subtypes. Likewise a service target results in the related price modifier being applied to all service items members of the specified service. Finally, the choice of all service items as the target results in the price modifier being applied to all service items in the specified provider system.

The last portion of the price program wizard is the Conditions GUI 204, which is shown in FIG. 10. Conditions GUI 204 is displayed when graphical button 206 is selected. This segment of the wizard allows the user to specify customer organizations to which the selected price program will apply. Menu 208 displays all available customer organizations and box 210 displays those organizations that have been selected for the associated price program.

The interrelation of the various screens of the price program module is shown in the flow chart in FIG. 11. Preferably, a user enters the price program module from the Price List page in step 212. Initiation of the price program wizard occurs in step 214 when a user selects a graphical button on navigation tab bar 174. The price program wizard 216 guides the user to enter information related to the price program, including general information in step 218, corresponding to GUI 170, modifier information in step 220, corresponding to GUI 186, target information in step 222, corresponding to GUI 196 and conditions information in step 224, corresponding to GUI 204. After supplying the relevant information, the user exits price program wizard 176, whereby the price program information is added to the database and entered on the price program list in step 226.

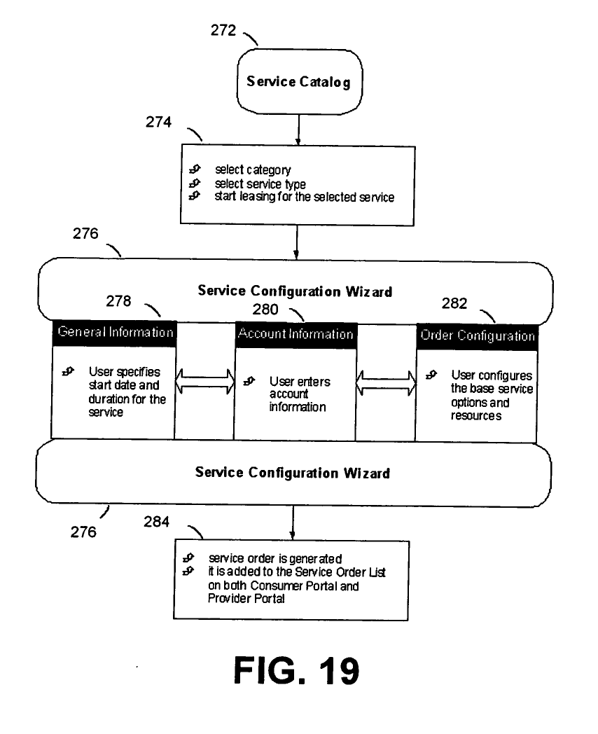

Like the provider portal, the consumer portal is preferably configured to allow a user to input information related to a requested service via a web-based interface. As such, the consumer portal provides organization to the information available to consumers and links to interfaces that enable consumers to input relevant information. For example, the operation of the consumer portal is depicted by the GUIs shown in FIGS. 12-18 and in the flow chart illustrated in FIG. 19. As discussed above, these operations allow a consumer to interact with the systems and programs of the invention to describe characteristics of a requested service and to select among the services offered by the various providers participating in the system. These characteristics are stored by the system in a database so that the broker application can manage the information and potential consumers of the service can access the information.

A service order begins with a user navigating from a main consumer portal dashboard that aggregates links to the various pages and modules appropriate for a consumer using the platform. Following initiation of a service order, Service Catalog GUI 230, shown in FIG. 12, is displayed. As can be appreciated, the Service Catalog reflects all the available services from partner service providers and through this interface, service consumers can browse and search for available service offerings. Menu 232 allows a user to select a desired service category and service type. Box 234 displays the individual services and associated information that are available corresponding to service type selected in menu 232. As shown, for example, within the “Hardware Services” service category, the service type “Workstations” has been selected leading to the display of four different laptop services in box 234.

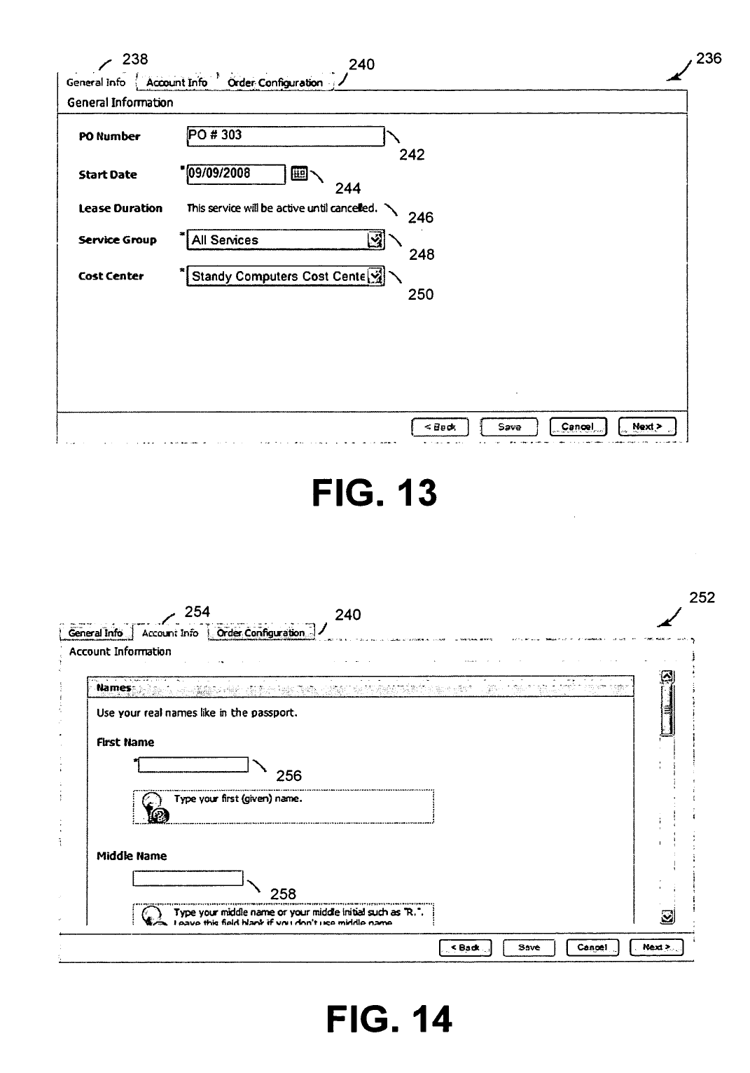

Following selection of a service from the Service Catalog, the core of the service order creation process is performed by a service configuration wizard module that prompts the user for relevant information using the three screens shown in FIGS. 13-15. First, General Information GUI 236 is displayed when a user selects graphical button 238 on navigation tab bar 240. Examples of information collected by GUI 236 include an order identifier in input text box 242, start date in input text box 244, preferably associated with a calendar popup, lease duration in box 246, service group in pull down menu 248 and cost center in pull down menu 250.

Next, Account Information GUI 252, as shown in FIG. 14, is displayed when graphical button 254 is selected. On this page, the user inputs specified account information, such as name in input text boxes 256 and 258. Preferably, the account information comprises a form created by the service provider.

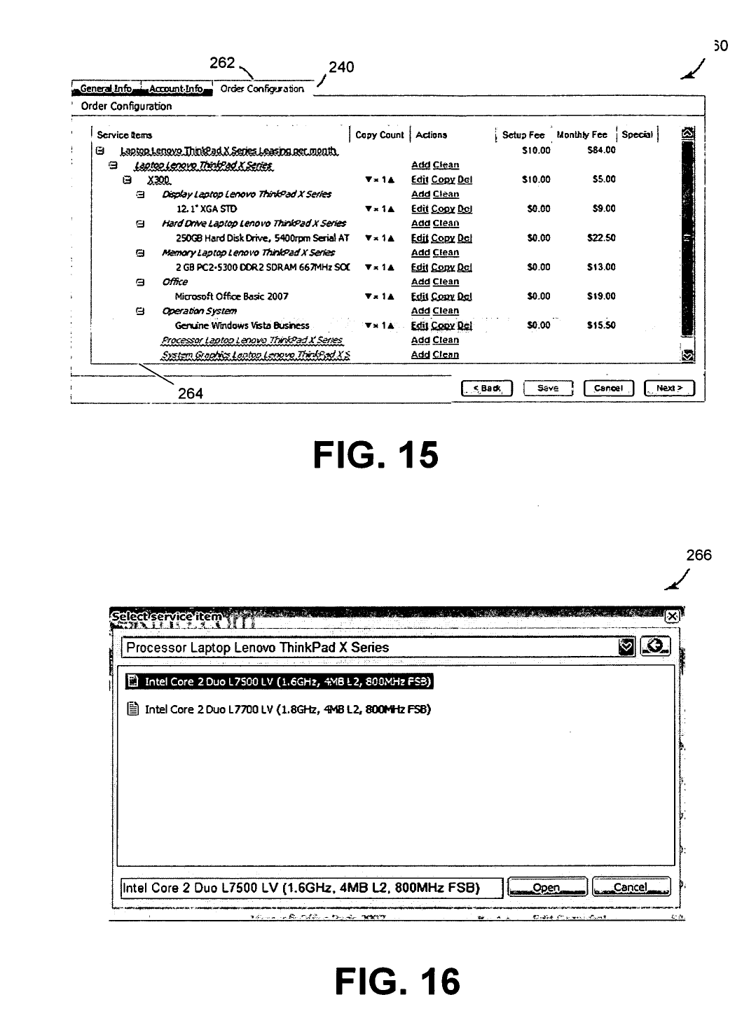

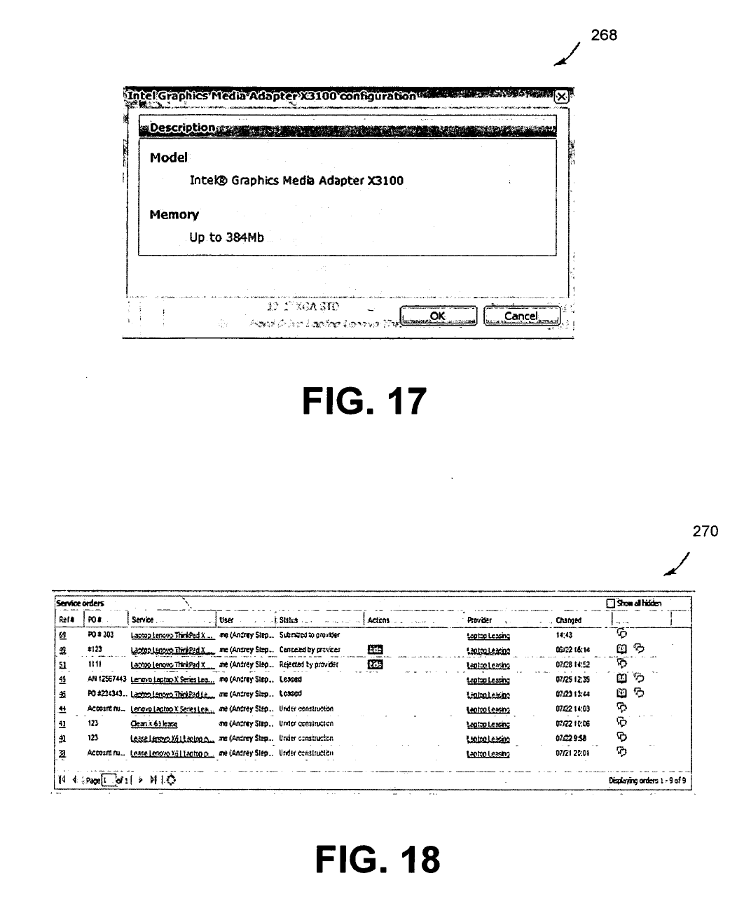

Finally, as shown in FIG. 15, Order Configuration GUI 260 is displayed when graphical button 262 is selected on navigation bar 240. This calls a service configurator module. Initialization of the service configurator populates it with the structure of the service which is being leased, options associated with the service, such as the associated service items, and other information as shown in display box 264. Tree items that are highlighted indicate service items being configured. As shown in FIGS. 16 and 17, popup dialog boxes 266 and 268 provide the user with the ability to select various options and configurations associated with the service item.

After all relevant information is input, the completed service order is added to the data base. If desired, aspects of the information prompted by these pages can automatically depend upon information supplied by the providers through the operation of the provider portal described above. As shown in FIG. 18, a service order list GUI 270 is displayed that conveys all completed service orders and selected information associated with each order. Preferably, service order list GUI 270 is accessible through both the consumer portal and the provider portal.

The above service order creation process is summarized in the flow chart shown in FIG. 19. In step 272, the user navigates to the service catalog GUI 230. Selecting a service category, service type and leasing from the catalog 230 in step 274 initiates service configuration wizard 276. As discussed above, service configuration wizard 276 prompts the user for general information in step 278, corresponding to GUI 236, account information in step 280, corresponding to GUI 252, and order configuration information in step 282, corresponding to GUI 260. Completion of service configuration wizard 276 leads to generation of the service order and the addition of the order to the service order list in step 284.

In order to manage multiple service providers and multiple service purchasers across multiple industries, the invention provides definable modules that can be customized for each party's purpose. Even though the modules are customizable, they contain a common framework that is understood by the system. In this fashion, modules may be tailored to fit the needs of service providers and service consumers, but may still be hosted on the common platform. The framework is implemented by an XML-based markup language called Service Definition Language (SDL). SDL enables providers and consumers to define the terms of the contract relationship. Further details regarding SDL are given in co-pending U.S. Provisional Application Ser. No. 60/997,258, filed Oct. 1, 2007, which is hereby incorporated by reference in its entirety.

SDL is a formal specification language that allows service providers and consumer to describe a offerings and requests using an XML format that is both human readable and can be parsed and processed by a computer system. The SDL provides a framework for message interactions between a service provider and service consumers using a standard, flexible, platform independent message format.

The language defines a syntax that enables service providers to fully describe their service offerings in a format that can be processed by a computer to automatically generate interactive order forms that consumers can use to select, self-customize, configure, and order a new service. The SDL allows the service provider to captures all information required for new service provisioning, such as available service options, associated pricing and specific buyer information.

Additionally, the SDL provides a mechanism for categorization of service offering types using templates that define attributes and properties of similar services that can be grouped to create taxonomies of service. At the same time, SDL allows for providers of similarly grouped services to differentiate their services from others by extending the template definition to suit their needs.

Services are defined by a set of one or more property groups, each of which contains a set of one or more properties. Each property is characterized by a set of attributes, such as name, description, and type (such as string, Boolean or integer) that together define what the property is and the nature of its property values.

Properties may have default values, and maybe defined as fixed or configurable. A fixed value is set by the provider, and may not be modified. Configurable properties allow a value to be specified when the service offering is configured for a specific consumer, such as when the customer is purchasing the service. Additionally, a set of allowable property values can be specified in an externally defined and managed list.

Properties may specify dependencies between properties and property values using logical expressions. For example, when leasing a dedicated server a customer may have the option to select from “single hard drive” or “dual hard drives” options, and additionally have the option to select “disk mirroring (RAID 1)”—but this option is only available if the customer has selected the “dual hard drives” option.

SDL allows for properties to be grouped together in a property group. A property group is a set of one or more individual properties that collectively describe an attribute or option of a service.

SDL allows for creation of compound services, which are comprised of individual services that can be purchased together on a single purchase order, with single pricing and contract. For example, a service provider offers configuration and leasing of an entire hosted application environment, comprised of individual servers, network, and bandwidth options, but all under single contract terms. The compound service includes, in its definition, a reference to another service, or services, that are defined in SDL.

In one exemplary usage of the present invention, a service provider creates different service specifications using the SDL to describe pre-configured service options, as well as a more configurable option that allows the user to specify most or all options, all using the same underlying service descriptions.

A service definition template represents a service category. Services that can be categorized by sharing the same base service definition template contain the properties defined therein. For example, a service definition template is created for a category “Dedicated Server Hosting” that defines properties such as “platform” and “operating system” that must be present for all services in this category. Service templates provide for services that are similar to one another be grouped together and share common properties to enable automation of search and compare functionality.

As indicated by its underlying XML foundation, the SDL is extensible to allow service providers to extend a standard service definition template to differentiate their services from similar services that can be categorized the same way using the same service definition template. An extended service definition template describes extra properties that describe non-standardized service attributes.

SDL provides for pricing options to be tied to the service definition. A service definition enables one-time fees to be expressed, as well fee calculation based on selected options. Periodic and utility pricing (pay for what you use) models are enabled by the system.

SDL defines auxiliary specifications to capture and pass additional information required for service provisioning and to describe administrative actions that are available for the service. Examples include a product specification that describes a service offering and available configuration options and their relationships, an account specification that captures end user information required to provision the user in a service provider's environment and an operation specification that captures information about what management features are supported by the service provider.

A specific embodiment of an SDL useful in the practice of the invention is discussed below. As used herein,

the term “Entity” means a single information object that can have set of relations to other sub-entities or entity classes;

the term “Relation” means relation between entities, particularly the “has-relation” where one entity has a set of other entities and the “generalization-relation” where entities can be classified and the classification represented as tree-like structure;

the term “Sub-entity” means an entity which represents a child-side of relation to another entity;

the term “Relation cardinality” means there are defined rule related to minimum and maximum quantities of sub-entities exhibiting a has-relation;

the term “Service Item” means a single entity;

the term “Service Item Type” means a class of entities;

the term “Service” means an entity representing a target that must be specified and configured; and

the term “Property” means a specific attribute of an entity.

SDL is configured to describe different aspects of unified services, thus SDL can describe a single entity specification, a single entity configuration and relations between entities and their cardinalities.

As described herein, the SDL specification and configuration share characteristics with XML documents. For example, an SDL document has template holding properties, which can be filled and selected. Properties can include possible variants if applicable. Specification does not depend on other documents. Further, a configuration document represents the current configuration for an entity, which is presented by its specification. Thus, configuration uses template holding properties to maintain one of the possible states for given entity and strictly depends on its specification. A configuration document comprises the properties described in the specification including configuration values, such as those selected by a user from a set of possible variants described in the specification. Preferably, the internal names of configuration's properties are the same as corresponding names in the parent specification.

In one embodiment, each SDL Specification document contains one <propertyGroups> tag describing the entity. The PropertyGroups specification tag contains the following dependent tags:

<name></name>—the name used to unique identify current SDL specification.

<propertyGroup></propertyGroup>—a required parameter, one or more elements of this type specify different property groups of the service.

The PropertyGroup specification tag specifys a single property group of the entity, such as address information. This tag contains the following dependent tags:

<name></name>—name of propertyGroup, a string value which is a required parameter.

<label></label>—a string value comprising text displayed to the user.

<description></description>—a string value comprising text displayed to the user.

<properties>—a holder of the entity properties belonging to the property group, which is a required parameter.

<availableWhen></availableWhen>—a tag that makes propertyGroup available when the logical expression is true.

<enableWhen></enableWhen>—a tag that makes Property Group read-only or not depending on the logical expression. If true, the associated propertyGroup's properties are editable. If this element exists in Property Group specification, the following <readonly></readonly> tag is ignored.

<readonly></readonly>—if this tag is true then all group properties are read-only and editable if false. As discussed above, the tag is ignored if <enableWhen></enableWhen> element is present in the specification.

The <properties> tag contains the list of <property> tags. The Property Specification tag specifies a single entity property and the possible available values set. The tag contains next the following dependent tags:

<name></name>—a string value representing the name of the property, which is a required parameter.

<label></label>—a string value comprising text displayed to the user.

<type></type>—the type of property, which is a required parameter and may be a string, numeric or boolean value.

<description></description>—a string value comprising text displayed to the user.

<mandatory></mandatory>—a boolean value that specifies whether the property is required or now. Thus, a true value indicates the property is mandatory.

<availableWhen></availableWhen>—a tag that makes propertyGroup available when the logical expression is true.

<enableWhen></enableWhen>—a tag that makes Property Group read-only or not depending on the logical expression. If true, the associated propertyGroup's properties are editable. If this element exists in Property Group specification, the following <readonly></readonly> tag is ignored.

<readonly></readonly>—if this tag is true then all group properties are read-only and editable if false.

As discussed above, the tag is ignored if <enableWhen></enableWhen> element is present in the specification.

<renderer></renderer>—a required parameter that specifies how the associated property is displayed. Possible values include:

TEXT_FIELD—edit box,

COMBO_BOX—combo box,

CHECK_BOX—check box to display Yes/No,

INFO_LABEL—static labeled text,

TEXT_AREA—text area element,

RADIO_BUTTON—radio button group.

Tags usage that depends on renderer type:

TEXT_FIELD

<defaultValue></defaultValue>—the default value of the property.

<min></min>—the minimum value of the property.

<max></max>—the maximum value of the property.

<measurementSystem></measurementSystem>—specifies the measurement system for the value.

COMBO_BOX

<measurementSystem></measurementSystem>—specifies the measurement system for the value.

<values></values>—a required parameter that specifies a data set and can include one or more <value> tags and at most one <default> tag.

<default></default>—a default value specified by the dataset.

<value>—specifies a data element.

<availableWhen></availableWhen>—a boolean value which makes the value tag available when true.

<label></label>—a required parameter comprising a string value represent text displayed to the user if available

<data></data>—a required parameter comprising a data element.

INFO_LABEL

<defaultValue></defaultValue>—a required parameter having a string value corresponding to descriptive text.

TEXT_AREA

<defaultValue></defaultValue>—contains the default value of the property.

CHECK_BOX

<defaultValue></defaultValue>—contains the default value of the property.

RADIO_BUTTON:

<values></values>—a required parameter specifying a data set. This tag may contain one or more <value> tags and at most one <default> tag.

<default></default>—a default value specified by the dataset.

<value>—specifies one data element.

<availableWhen></availableWhen>—a boolean value which makes the value tag available when true.

<label></label>—a required parameter comprising a string value represent text displayed to the user if available

<data></data>—a required parameter comprising a data element.

Each SDL Configuration document contains one <propertyGroups> tag, which specifies one entity configuration. As discussed above, the structure of the Configuration document reflects the structure of the Specification document to which it corresponds. Preferably, if some elements of specification are disabled in by the values associated with the <availableWhen></availableWhen> or <enableWhen></enableWhen> tags, these elements are represented in the configuration only by the <name></name> sub-element.

The PropertyGroups configuration tag contains the following dependent tags:

<name></name>—the name used to uniquely identify the current SDL specification and is a required parameter.

<propertyGroup></propertyGroup>—holds one or more property groups, which specify different aspects of the entity and is a required parameter.

PropertyGroup configuration tag specifies a single property group of the entity, such as address information. The tag has the following dependent tags:

<name></name> a required string value that holds the name of the propertyGroup.

<properties>—holder of the entity properties, which belongs to the property group.

The <properties> element contains the list of <property> tags.

The Property configuration tag holds the value of the property specified in specification document. The tag has the following dependent tags:

<name></name>—a required parameter having a string value specifying the name of the property.

<value></value>—specifies the value for the current property.

Service configuration represents a completely configured service. It consists of entity configurations described in previous section and completely specified relations between them. The Service Item tag has the following dependent tags holding the associated values:

<id></id>—the identifier of the item.

<name></name>—the name of the item.

<organizationId></organizationId>—the holds the organizationId.

<durationUnit></durationUnit>—holds the duration unit, such as day, week, month, or year.

<price></price>—the item price tags.

<specification></specification>—the item specification using the underlying structure specified in the Entity Specification section.

<configuration></configuration>—the configuration of item using the underlying structure specified in Entity Specification section.

<relations></relations>—the item—and type-relations, if such relations exist.

Price of Root Service Item is a tag having the following dependent tags:

<actual></actual>—the actual price, which has the following dependent tags holding the associated values:
<setupFee></setupFee>—the service setup fee, preferably in cents.
<periodicalFee></periodicalFee>—the periodical fee, preferably in cents.
<isMetered></isMetered> the metering flag, so that if true the price has a metered component.
<meteredDescription></meteredDescription>—the metered component description.

Price of Service Item is a tag having the following dependent tags holding the associated values:

<priceProgram></priceProgram>—the price program, a has the following dependent tags:
<name></name>—the name of price program.
<priceModifier></priceModifier>—specifies the price modification and has the following dependent tags that hold the associated values:
   <modifier></modifier>—the price modifier.
   <meteredModifier/>—the metered price modifier.
   <overrideByMeteredModifier></overrideByMeteredModifier>—the metered modifier descriptor
   <actual></actual>—the actual item price, has the following dependent tags that hold the associated values:
      <setupFee></setupFee>—the actual setup fee of item, preferably in cents.
      <periodicalFee></periodicalFee>—the actual periodical fee of item, preferably in cents.
      <isMetered></isMetered> the metering flag, so that if true the price has a metered component.
      <meteredDescription></meteredDescription>—the metered component description.
      <original></original>—the original item price, has the following dependent tags that hold the associated values:
         <setupFee></setupFee>—original item setup fee in cents.
         <periodicalFee></periodicalFee>—the actual periodical fee of item, preferably in cents.
         <isMetered></isMetered> the metering flag, so that if true the price has a metered component.
         <meteredDescription></meteredDescription>—the metered component description.

The Relations of Service Item tag has the following dependent tags:

<typeRelation></typeRelation>—identifies the relation-type item and is an optional tag. It has the following dependent tags:
<id></id>—holds id of item type.
<name></name>—holds name of item type.
<min></min>—holds minimal allowed count of items in the relation.
<max></max>—holds maximum allowed count of items in the relation
<allowCopies></allowCopies>—specification of the item.
<serviceItems></serviceItems>—holds separate service items, which belongs to the relation.
<itemRelation></itemRelation>—holds the relation item and is an optional tag, which contains the following dependent tags:
   <id></id>—holds id of item.
   <name></name>—holds name of item.
   <min></min>—holds minimal allowed count of items in the relation.
   <max></max>—holds maximum allowed count of items in the relation
   <specification></specification>—specification of the item.
   <serviceItems></serviceItems>—holds separate service items, which belongs to the relation.

Examples of SDL usage are given in Tables 1-7, attached hereto. As will be appreciated, Table 1 is an example of a common schema establishing definitions that are commonly used by the remaining SDL documents. Table 2 is an example of a schema for a Property Group specification and Table 3 is an associated SDL specification document. Table 4 is a schema for a Property Group configuration and Table 5 is an associated SDL configuration document. Finally, Table 6 is a schema for a service configuration and Table 7 is the associated SDL service configuration document.

There are a number of attributes, characteristics and descriptors that may be used in establishing the parameters of SDL for a given service. For example, descriptors of the benefits associated with the service available and usable by any consumer preferably use consistent, industry-accepted terms. The functional parameters associated with the service should be identified. For services that are location dependent should specify delivery. Iterations of the service should be specified based upon the number of intended users represented by the consumer. If the service is not available continuously, the accessible times should be specified. Support resources associated with the service should also be specified, including the languages available. Contract fulfillment criteria should be specified to enable assessment of satisfactory service delivery. Similarly, terms to specify the maximum permissible duration of service interruption should be included. As discussed above, the period of delivering the service should be specified. The granularity of the service unit should be specified for purposes of establishing price. Finally, as also discussed above, the various components that establish price, including setup fees, periodic fees and metered fees should be accommodated by the SDL. As one having skill in the art will appreciate, any other suitable characteristics particular to a given service can be accommodated due to the extensible nature of the SDL.

Preferably, the invention is a single platform for service providers and service purchasers across multiple industries. Rather than requiring a custom-built platform for each party or industry, the invention allows all industries to work with a single platform that is customizable and extensible for many purposes.

In an embodiment, the invention is a system for receiving offers for services from independent service providers. An offer for a service can be a contract with a time duration and terms that are specific to the service provider, including the particular services that are provided and the payment for the provided services.

In another embodiment, the invention is a system for receiving search strings for services from service purchasers. A service purchaser in need of a variety of services can use the invention as a single interface for locating and obtaining services for a specified duration of time.

In a further aspect of the invention, the platform provides a system for managing the relationships formed between service providers and service purchasers, reminding parties to fulfill defined obligations tracked by the system. These obligations are defined by the parties, and can be changed without requiring the formation of new relationships or contracts or service agreements. Preferably, once a service purchaser accepts and subscribes to the services offered by a service provider, the platform may be used as single access point for monitoring the performance of the subscribed services, and tracking consideration for the subscribed services.

In yet another embodiment, the invention is a searchable database for storing descriptions of the services offered by providers, as well as a database for storing the terms of the service agreements accepted by the service purchasers.

One presently preferred application of the systems and methods of the invention deals with transactions associated with Information Technology services, such as server hosting, storage, or Software-as-a-Service (SaaS). For example, SaaS is a model of software delivery that is increasing in popularity. A software vendor hosts and operates an application for use by third-party consumers over the Internet. The consumers lease usage of the managed application, as opposed to purchasing a license to the software and hosting and operating it themselves operates an application for use by third-party consumers over the Internet. The consumers lease usage of the managed application, as opposed to purchasing a license to the software and hosting and operating it themselves. Accordingly, the system and methods of the invention a particularly suited to transactions involving SaaS applications and other IT services.

In another aspect of the invention, the open nature of the SDL data allows providers and consumers to bypass the web-based entry of information through wizards. Instead, provider and consumers can transmit appropriate SDL documents that are generated by another system directly to the platform, allowing the information contained within to be parsed and added to the database.

Also preferably, the systems and methods of the invention may have automatic notification elements for notifying a consumer of offered services newly-entered into the database that match selection criteria previously specified by the consumer. In another preferred embodiment, the provider portal is configured to prompt a predefined minimum set of information in association with a given service or service type.

The invention differs from prior art systems in that party relationships are maintained for a defined duration of time, rather than being limited to a single transaction, as is common with standard E-Commerce sites associated with goods. Further, the platform is not simply a collection of web applications available to users, but rather a platform-independent conduit for listing services and managing relationships between service providers and service purchasers.

One will appreciate that in the description above and throughout, numerous specific details are set forth in order to provide a thorough understanding of the present invention. It will be evident, however, to one of ordinary skill in the art, that the present invention may be practiced without these specific details. Further, one of skill in the art will also understand that there are equivalent alternative embodiments. For example, the above discussion has focussed on transactions involving services. However, the concepts and features of the invention can be extended to transactions of goods, as well. In other instances, well-known structures and devices are shown in block diagram form to facilitate explanation. The description of the preferred embodiments is not intended to limit the scope of the claims appended hereto.

```
TABLE 1
<xsd:schema xmlns=“http://company.com/gulfstream/schema”
      xmlns:xsd=“http://www.w3.org/2001/XMLSchema”
      targetNamespace=“http://company.com/gulfstream/schema”
      elementFormDefault=“qualified”>
  <xsd:complexType name=“pgsConfType”>
    <xsd:sequence>
      <xsd:element name=“name” type=“nameIdentificator” minOccurs=“1”
maxOccurs=“1”/>
      <xsd:element name=“propertyGroup” type=“pgConfType” minOccurs=“1”
maxOccurs=“unbounded”/>
    </xsd:sequence>
  </xsd:complexType>
  <xsd:complexType name=“pgConfType”>
    <xsd:all>
      <xsd:element name=“name” type=“nameIdentificator” minOccurs=“1” />
      <xsd:element name=“properties” type=“propsConfType” minOccurs=“0” />
    </xsd:all>
  </xsd:complexType>
  <xsd:complexType name=“propsConfType”>
    <xsd:sequence>
      <xsd:element name=“property” type=“propConfType” minOccurs=“0”
maxOccurs=“unbounded”/>
    </xsd:sequence>
  </xsd:complexType>
  <xsd:complexType name=“propConfType”>
      <xsd:all>
        <xsd:element name=“name” type=“nameIdentificator” minOccurs=“1”/>
        <xsd:element name=“value” type=“xsd:string” minOccurs=“0”/>
      </xsd:all>
  </xsd:complexType>
  <xsd:complexType name=“pgsSpecType”>
    <xsd:sequence>
    <xsd:element name=“name” type=“nameIdentificator” minOccurs=“1”
maxOccurs=“1”/>
    <xsd:element name=“propertyGroup” type=“pgSpecType” minOccurs=“1”
maxOccurs=“unbounded”/>
    </xsd:sequence>
  </xsd:complexType>
  <xsd:complexType name=“pgSpecType”>
    <xsd:all>
      <xsd:element name=“name” type=“nameIdentificator” minOccurs=“1” />
      <xsd:element name=“label” type=“xsd:string” minOccurs=“0” />
      <xsd:element name=“description” type=“xsd:string” minOccurs=“0” />
      <xsd:element ref=“readonly” minOccurs=“0” />
      <xsd:element name=“enableWhen” type=“xsd:string” minOccurs=“0” />
      <xsd:element name=“availableWhen” type=“xsd:string” minOccurs=“0” />
      <xsd:element name=“properties” type=“propsSpecType” minOccurs=“1” />
    </xsd:all>
  </xsd:complexType>
  <xsd:complexType name=“propsSpecType”>
    <xsd:sequence>
      <xsd:element name=“property” type=“propSpecType” minOccurs=“0”
maxOccurs=“unbounded”/>
    </xsd:sequence>
  </xsd:complexType>
  <xsd:complexType name=“propSpecType”>
    <xsd:all>
      <xsd:element name=“name” type=“nameIdentificator” minOccurs=“1”/>
      <xsd:element name=“label” type=“xsd:string” minOccurs=“0”/>
      <xsd:element name=“description” type=“xsd:string” minOccurs=“0”/>
      <xsd:element ref=“type” minOccurs=“1” />
      <xsd:element ref=“renderer” minOccurs=“1” />
      <xsd:element ref=“readonly” minOccurs=“0” />
      <xsd:element ref=“mandatory” minOccurs=“0” />
      <xsd:element name=“enableWhen” type=“xsd:string” minOccurs=“0” />
      <xsd:element name=“availableWhen” type=“xsd:string” minOccurs=“0” />
      <xsd:element name=“measurementSystem” type=“xsd:string” minOccurs=“0” />
      <xsd:element name=“defaultValue” type=“xsd:string” minOccurs=“0”/>
      <xsd:element name=“min” type=“xsd:string” minOccurs=“0” />
      <xsd:element name=“max” type=“xsd:string” minOccurs=“0” />
      <xsd:element ref=“values” minOccurs=“0”/>
    </xsd:all>
  </xsd:complexType>
  <xsd:element name=“type” type=“propertyType” />
  <xsd:element name=“readonly” type=“booleanType” />
  <xsd:element name=“mandatory” type=“booleanType” />
  <xsd:element name=“renderer” type=“rendererType” />
  <xsd:simpleType name=“propertyType”>
    <xsd:restriction base=“xsd:string”>
      <xsd:enumeration value=“STRING”/>
      <xsd:enumeration value=“NUMERIC”/>
      <xsd:enumeration value=“BOOLEAN”/>
    </xsd:restriction>
  </xsd:simpleType>
  <xsd:simpleType name=“rendererType”>
    <xsd:restriction base=“xsd:string”>
      <xsd:enumeration value=“TEXT_FIELD” />
      <xsd:enumeration value=“COMBO_BOX” />
      <xsd:enumeration value=“CHECK_BOX” />
      <xsd:enumeration value=“INFO_LABEL” />
      <xsd:enumeration value=“TEXT_AREA” />
      <xsd:enumeration value=“RADIO_BUTTON” />
    </xsd:restriction>
  </xsd:simpleType>
  <xsd:element name=“values”>
    <xsd:complexType>
      <xsd:sequence>
        <xsd:element name=“value” type=“valueType” maxOccurs=“unbounded”
minOccurs=“1”/>
        <xsd:element name=“default” type=“xsd:string” minOccurs=“0”
maxOccurs=“1”/>
      </xsd:sequence>
    </xsd:complexType>
  </xsd:element>
  <xsd:complexType name=“valueType”>
      <xsd:all>
        <xsd:element name=“data” type=“xsd:string” minOccurs=“1”/>
        <xsd:element name=“label” type=“xsd:string” minOccurs=“1”/>
      </xsd:all>
  </xsd:complexType>
  <xsd:simpleType name=“booleanType”>
    <xsd:restriction base=“xsd:string”>
      <xsd:whiteSpace value=“collapse” />
      <xsd:enumeration value=“true” />
      <xsd:enumeration value=“false” />
    </xsd:restriction>
  </xsd:simpleType>
  <xsd:simpleType name=“countType”>
    <xsd:restriction base=“xsd:integer”>
      <xsd:minInclusive value=“1”/>
    </xsd:restriction>
  </xsd:simpleType>
  <xsd:simpleType name=“nonNegativeIntegerType”>
    <xsd:restriction base=“xsd:integer”>
      <xsd:minInclusive value=“0”/>
    </xsd:restriction>
  </xsd:simpleType>
  <xsd:simpleType name=“nameIdentificator”>
    <xsd:restriction base=“xsd:string”>
      <xsd:whiteSpace value=“collapse”/>
      <xsd:pattern value=“[a-zA-Z_]+[a-zA-Z_0-9]*”/>
    </xsd:restriction>
  </xsd:simpleType>
</xsd:schema>
```

```
TABLE 2
<xsd:schema xmlns=“http://company.com/gulfstream/schema”
      xmlns:xsd=“http://www.w3.org/2001/XMLSchema”
      targetNamespace=“http://company.com/gulfstream/schema”
      elementFormDefault=“qualified”>
  <xsd:include schemaLocation =
“http://griddynamics.com/gulfstream/schema/commonSchema.xsd” />
  <xsd:element name=“propertyGroups” type=“pgsSpecType” />
</xsd:schema>
```

TABLE 3

```
<propertyGroups>
  <name>OrganizationProfile</name>
  <propertyGroup>
    <name>GeneralInformation</name>
    <label>General Information</label>
    <description>Enter your business official basic
    information.</description>
    <properties>
      <property>
        <name>Name</name>
        <label>Name</label>
        <mandatory>true</mandatory>
        <renderer>TEXT_FIELD</renderer>
        <type>STRING</type>
      </property>
      <property>
        <name>URL</name>
        <label>URL</label>
        <description>For example,
        quot;http://your.business.com&quot;.</description>
        <renderer>TEXT_FIELD</renderer>
        <type>STRING</type>
      </property>
      <property>
        <name>Address</name>
        <label>Address</label>
        <renderer>TEXT_AREA</renderer>
        <type>STRING</type>
      </property>
    </properties>
  </propertyGroup>
  <propertyGroup>
    <properties>
      <property>
        <name>EmployeesCount</name>
        <label>Employees Count</label>
        <renderer>COMBO_BOX</renderer>
        <type>STRING</type>
        <values>
          <value>
            <label>Above 10</label>
            <data>Above10</data>
          </value>
          <value>
            <label>10-100</label>
            <data>10-100</data>
          </value>
          <value>
            <label>100-1000</label>
            <data>100-1000</data>
          </value>
          <value>
            <label>1000+</label>
            <data>1000+</data>
          </value>
          <default>Above10</default>
        </values>
      </property>
    </properties>
    <name>AdditionalInformation</name>
    <label>Additional Information</label>
  </propertyGroup>
</propertyGroups>
```

```
TABLE 4
<xsd:schema xmlns=“http://company.com/gulfstream/schema”
      xmlns:xsd=“http://www.w3.org/2001/XMLSchema”
      targetNamespace=“http://griddynamics.com/gulfstream/schema”
      elementFormDefault=“qualified”>
  <xsd:include schemaLocation =
“http://griddynamics.com/gulfstream/schema/commonSchema.xsd” />
  <xsd:element name=“propertyGroups” type=“pgsConfType” />
</xsd:schema>
```

TABLE 5

```
<propertyGroups>
  <name>OrganizationProfile</name>
  <propertyGroup>
    <name>GeneralInformation</name>
    <properties>
      <property>
        <name>Name</name>
        <value>Company 2</value>
      </property>
      <property>
        <name>URL</name>
        <value>http://company2.com</value>
      </property>
      <property>
        <name>Address</name>
        <value>123 Some street
          Some City
          1234, CT
          USA
        </value>
      </property>
    </properties>
  </propertyGroup>
  <propertyGroup>
    <name>AdditionalInformation</name>
    <properties>
      <property>
        <name>EmployeesCount</name>
        <value>Above10</value>
      </property>
    </properties>
  </propertyGroup>
</propertyGroups>
```

```
TABLE 6
<xsd:schema xmlns=“http://company.com/gulfstream/schema”
      xmlns:xsd=“http://www.w3.org/2001/XMLSchema”
      targetNamespace=“http://company.com/gulfstream/schema”
      elementFormDefault=“qualified”>
  <xsd:include schemaLocation =
“http://company.com/gulfstream/schema/commonSchema.xsd” />
  <xsd:element name=“serviceItem” type=“rootItemType” />
  <xsd:complexType name=“itemType”>
    <xsd:sequence>
      <xsd:element name=“name” type=“xsd:string” minOccurs=“1” maxOccurs=“1” />
      <xsd:element name=“copyCount” type=“countType” minOccurs=“1”
maxOccurs=“1” />
      <xsd:element name=“price” type=“itemPrice” minOccurs=“1” maxOccurs=“1” />
      <xsd:element ref=“configuration” minOccurs=“1” maxOccurs=“1” />
      <xsd:element ref=“relations” minOccurs=“1” maxOccurs=“1” />
    </xsd:sequence>
  </xsd:complexType>
  <xsd:complexType name=“rootItemType”>
    <xsd:sequence>
      <xsd:element name=“id” type=“xsd:string” minOccurs=“1” maxOccurs=“1” />
      <xsd:element name=“name” type=“xsd:string” minOccurs=“1” maxOccurs=“1” />
      <xsd:element name=“organizationId” type=“xsd:string” minOccurs=“1”
maxOccurs=“1”/>
      <xsd:element name=“durationUnit” type=“durationUnitType” minOccurs=“1”
maxOccurs=“1”/>
      <xsd:element name=“price” type=“rootItemPrice” minOccurs=“1”
maxOccurs=“1” />
      <xsd:element name=“specification” type=“xsd:string” minOccurs=“1”
maxOccurs=“1” />
      <xsd:element name=“configuration” type=“xsd:string” minOccurs=“1”
maxOccurs=“1” />
      <xsd:element ref=“relations” minOccurs=“1” maxOccurs=“1” />
    </xsd:sequence>
  </xsd:complexType>
  <xsd:complexType name=“typeRelationItemType”>
    <xsd:sequence>
      <xsd:element name=“id” type=“xsd:string” minOccurs=“1” maxOccurs=“1” />
      <xsd:element name=“name” type=“xsd:string” minOccurs=“1” maxOccurs=“1” />
      <xsd:element name=“copyCount” type=“countType” minOccurs=“1”
maxOccurs=“1” />
      <xsd:element name=“price” type=“itemPrice” minOccurs=“1” maxOccurs=“1” />
      <xsd:element ref=“specification” minOccurs=“1” maxOccurs=“1” />
      <xsd:element ref=“configuration” minOccurs=“1” maxOccurs=“1” />
      <xsd:element ref=“relations” minOccurs=“1” maxOccurs=“1” />
    </xsd:sequence>
  </xsd:complexType>
  <xsd:complexType name=“typeRelationServiceItemsType”>
    <xsd:sequence>
      <xsd:element name=“serviceItem” type=“typeRelationItemType” minOccurs=“0”
maxOccurs=“unbounded” />
    </xsd:sequence>
  </xsd:complexType>
  <xsd:complexType name=“itemRelationServiceItemsType”>
    <xsd:sequence>
      <xsd:element name=“serviceItem” type=“itemType” minOccurs=“0”
maxOccurs=“unbounded” />
    </xsd:sequence>
  </xsd:complexType>
  <xsd:element name=“relations”>
    <xsd:complexType>
      <xsd:sequence>
        <xsd:element ref=“typeRelation” minOccurs=“0” maxOccurs=“unbounded” />
        <xsd:element ref=“itemRelation” minOccurs=“0” maxOccurs=“unbounded” />
      </xsd:sequence>
    </xsd:complexType>
  </xsd:element>
  <xsd:element name=“typeRelation”>
    <xsd:complexType>
      <xsd:sequence>
        <xsd:element name=“id” type=“xsd:string” minOccurs=“1” maxOccurs=“1” />
        <xsd:element name=“name” type=“xsd:string” minOccurs=“1” maxOccurs=“1”
/>
        <xsd:element name=“min” type=“nonNegativeIntegerType” minOccurs=“1”
maxOccurs=“1” />
        <xsd:element name=“max” type=“nonNegativeIntegerType” minOccurs=“1”
maxOccurs=“1” />
        <xsd:element name=“allowCopies” type=“booleanType” minOccurs=“1”
maxOccurs=“1” />
        <xsd:element name=“serviceItems” type=“typeRelationServiceItemsType”
minOccurs=“1” maxOccurs=“1” />
      </xsd:sequence>
    </xsd:complexType>
  </xsd:element>
  <xsd:element name=“itemRelation”>
    <xsd:complexType>
      <xsd:sequence>
        <xsd:element name=“id” type=“xsd:string” minOccurs=“1” maxOccurs=“1” />
        <xsd:element name=“name” type=“xsd:string” minOccurs=“1” maxOccurs=“1”
/>
        <xsd:element name=“min” type=“nonNegativeIntegerType” minOccurs=“1”
maxOccurs=“1” />
        <xsd:element name=“max” type=“nonNegativeIntegerType” minOccurs=“1”
maxOccurs=“1” />
        <xsd:element ref=“specification” minOccurs=“1” maxOccurs=“1” />
        <xsd:element name=“serviceItems” type=“itemRelationServiceItemsType”
minOccurs=“1” maxOccurs=“1” />
      </xsd:sequence>
    </xsd:complexType>
  </xsd:element>
  <xsd:element name=“specification”>
    <xsd:complexType>
      <xsd:sequence>
        <xsd:element name=“propertyGroups” type = “pgsSpecType” minOccurs=“0”
maxOccurs=“1” />
      </xsd:sequence>
    </xsd:complexType>
  </xsd:element>
  <xsd:element name=“configuration”>
    <xsd:complexType>
      <xsd:sequence>
        <xsd:element name=“propertyGroups” type = “pgsConfType” minOccurs=“0”
maxOccurs=“1” />
      </xsd:sequence>
    </xsd:complexType>
  </xsd:element>
  <xsd:complexType name=“simplePrice”>
    <xsd:sequence>
      <xsd:element name=“setupFee” type=“nonNegativeIntegerType” minOccurs=“1”
maxOccurs=“1”/>
      <xsd:element name=“periodicalFee” type=“nonNegativeIntegerType”
minOccurs=“1” maxOccurs=“1”/>
      <xsd:element name=“isMetered” type=“booleanType” minOccurs=“1”
maxOccurs=“1”/>
      <xsd:element name=“meteredDescription” type=“xsd:string” minOccurs=“1”
maxOccurs=“1”/>
    </xsd:sequence>
  </xsd:complexType>
  <xsd:element name=“priceProgram”>
    <xsd:complexType>
      <xsd:sequence>
        <xsd:element name=“name” type = “xsd:string” minOccurs=“1”
maxOccurs=“1” />
        <xsd:element ref=“priceModifier” minOccurs=“1” maxOccurs=“1” />
      </xsd:sequence>
    </xsd:complexType>
  </xsd:element>
  <xsd:element name=“priceModifier”>
    <xsd:complexType>
      <xsd:sequence>
        <xsd:element name=“modifier” type = “xsd:string” minOccurs=“1”
maxOccurs=“1” />
        <xsd:element name=“meteredModifier” type = “xsd:string” minOccurs=“1”
maxOccurs=“1” />
        <xsd:element name=“overrideByMeteredModifier” type = “booleanType”
minOccurs=“1” maxOccurs=“1” />
      </xsd:sequence>
    </xsd:complexType>
  </xsd:element>
  <xsd:element name=“actual” type = “simplePrice”/>
  <xsd:element name=“original” type = “simplePrice”/>
  <xsd:complexType name=“itemPrice”>
    <xsd:sequence>
      <xsd:element ref=“priceProgram” minOccurs=“1” maxOccurs=“1” />
      <xsd:element ref=“actual” minOccurs=“1” maxOccurs=“1” />
      <xsd:element ref=“original” minOccurs=“1” maxOccurs=“1” />
    </xsd:sequence>
  </xsd:complexType>
  <xsd:complexType name=“rootItemPrice”>
    <xsd:sequence>
      <xsd:element ref=“actual” minOccurs=“1” maxOccurs=“1”/>
    </xsd:sequence>
  </xsd:complexType>
  <xsd:simpleType name=“durationUnitType”>
    <xsd:restriction base=“xsd:string”>
      <xsd:whiteSpace value=“collapse” />
      <xsd:enumeration value=“day” />
      <xsd:enumeration value=“week” />
      <xsd:enumeration value=“month” />
      <xsd:enumeration value=“year” />
    </xsd:restriction>
  </xsd:simpleType>
</xsd:schema>
```

TABLE 7

```
<serviceItem>
  <id>4028903e1c65df20011c661dd2a20010</id>
  <name>QuickBooks</name>
    <organizationId>4e61d7cd15626fca01156396d1920068
    </organizationId>
  <durationUnit>month</durationUnit>
  <price>
    <actual>
      <setupFee>100000</setupFee>
      <periodicalFee>50000</periodicalFee>
      <isMetered>false</isMetered>
      <meteredDescription/>
    </actual>
  </price>
  <specification/>
  <configuration/>
  <relations>
    <itemRelation>
      <id>4028903e1c65df20011c661b463a000e</id>
      <name>QuickBooks</name>
      <mm>1</min>
      <max>1</max>
      <specification>
        <propertyGroups>
          <name>PropertyGroups</name>
          <propertyGroup>
            <name>General</name>
            <properties>
              <property>
                <name>TYPE</name>
                <label>Select QuickBook Type</label>
                <mandatory>true</mandatory>
                <renderer>COMBO_BOX</renderer>
                <type>STRING</type>
                <values>
                  <value>
                    <label>Pro</label>
                    <data>Pro</data>
                  </value>
                  <value>
                    <label>Premier</label>
                    <data>Premier</data>
                  </value>
                  <value>
                    <label>Enterprise Solutions</label>
                    <data>Enterprise Solutions</data>
                  </value>
                  <value>
                    <label>Online</label>
                    <data>Online</data>
                  </value>
                </values>
              </property>
            </properties>
          </propertyGroup>
        </propertyGroups>
      </specification>
      <serviceItems>
        <serviceItem>
          <name>QuickBooks</name>
          <copyCount>1</copyCount>
          <price>
            <priceProgram>
              <name/>
              <priceModifier>
                <modifier/>
                <meteredModifier/>
                <overrideByMeteredModifier>false
                </overrideByMeteredModifier>
              </priceModifier>
            </priceProgram>
            <actual>
              <setupFee>100000</setupFee>
              <periodicalFee>50000</periodicalFee>
              <isMetered>false</isMetered>
              <meteredDescription/>
            </actual>
            <original>
              <setupFee>100000</setupFee>
              <periodicalFee>50000</periodicalFee>
              <isMetered>false</isMetered>
              <meteredDescription/>
            </original>
          </price>
          <configuration>
            <propertyGroups>
              <name>PropertyGroups</name>
              <propertyGroup>
                <name>General</name>
                <properties>
                  <property>
                    <name>TYPE</name>
                    <value>Premier</value>
                  </property>
                </properties>
              </propertyGroup>
            </propertyGroups>
          </configuration>
          <relations/>
        </serviceItem>
      </serviceItems>
    </itemRelation>
  </relations>
</serviceItem>
```

What is claimed is:

1. In a computer system for brokering transactions for services between at least one provider and at least one consumer, a method for forming a transaction involving a service offered by a provider between a provider and a consumer comprising the steps of:
a) providing a provider portal configured to accept information from the provider specifying characteristics of an offered service;
b) storing the provider information to a database, wherein the database comprises a service catalog having the offered service grouped by at least one characteristic of the offered service;
c) providing a consumer portal configured to accept information from a consumer;
d) displaying the service catalog having the offered service through the consumer portal; and
e) forming a transaction for the offered service upon selection by the consumer, wherein the transaction is based upon the characteristics of the offered service.

2. The method of claim 1, wherein the offered service is grouped by service category.

3. The method of claim 2, wherein the offered service is further grouped by service type.

4. The method of claim 1, wherein the information from the provider includes at least one associated service item option for configuring the offered service.

5. The method of claim 4, wherein the step of storing the provider information further comprises grouping the associated service item by service item type.

6. The method of claim 4, wherein the step of displaying the service catalog further comprises displaying the associated service item option with the offered service.

7. The method of claim 6, wherein the step of forming a transaction for the offered service occurs upon selection of the associated service item option and wherein the transaction is based upon the characteristics of the offered service and the associated service item option.

8. The method of claim 1, wherein the steps of providing a provider portal and providing a consumer portal comprise providing a web browser-based interface that allows providers and consumers to input characteristics associated with the service.

9. The method of claim 8, wherein the provider portal is configured to prompt the provider with specific options depending upon the offered service.

10. The method of claim 9, wherein the provider portal further comprises a price program module that prompts the provider for information related to pricing.

11. The method of claim 10, wherein the information related to pricing is selected from the group consisting of set up fee, periodical fee and metered price.

12. The method of claim 2, wherein the consumer portal is configured to prompt the consumer for information associated with the offered service.

13. The method of claim 12, wherein the information associated with the offered service is derived from the provider information.

14. The method of claim 1, wherein the step of storing the provider information comprises translating the provider information into data stored in an extensible markup language.

15. The method of claim 14, wherein the extensible markup language is a Service Definition Language.

16. The method of claim 15, wherein the Service Definition Language comprises a plurality of properties and wherein the step of translating provider information comprises assigning a value corresponding to the offered service to at least one of the properties.

17. The method of claim 1, further comprising the steps of, after forming the transaction, receiving information from at least one of the consumer and the provider related to the transaction and modifying terms of the transaction based upon the received information.

18. The method of claim 1, further comprising the steps of, after forming the transaction, receiving information from at least one of the consumer and the provider related to the transaction and displaying information related to performance of the transaction based upon the received information.

19. The method of claim 1, wherein the offered service is an information technology service.

20. The method of claim 19, wherein the offered service is selected from the group consisting of server hosting, storage, and software-as-a-service.

21. A computer readable medium for use in a computer system computer system for brokering transactions for services between a provider and a consumer, wherein the computer readable medium has computer executable instructions for:
a) providing a provider portal configured to accept information from the provider specifying characteristics of an offered service;
b) storing the provider information to a database, wherein the database comprises a service catalog having the offered service grouped by at least one characteristic of the offered service;
c) providing a consumer portal configured to accept information from a consumer;
d) displaying the service catalog having the offered service through the consumer portal; and
e) forming a transaction for the offered service upon selection by the consumer, wherein the transaction is based upon the characteristics of the offered service.

22. The computer readable medium of claim 21, wherein the offered service is grouped by service category.

22. The computer readable medium of claim 22 wherein the offered service is further grouped by service type.

23. The computer readable medium of claim 21, wherein the information from the provider includes at least one associated service item option for configuring the offered service.

24. The computer readable medium of claim 21, wherein the instructions for providing a provider portal and providing a consumer portal are configured to provide a web browser-based interface that allows providers and consumers to input characteristics associated with the service.

25. The computer readable medium of claim 21, wherein the instructions for storing the provider information to a database are configured to translate the provider information into an extensible markup language.

26. The computer readable medium of claim 25, wherein the extensible markup language is a Service Definition Language.

27. The computer readable medium of claim 26, wherein the Service Definition Language comprises a plurality of properties and wherein the translation of provider information comprises assigning a value corresponding to the offered service to at least one of the properties.

28. A computer system for brokering transactions for services between at least one provider and at least one consumer, wherein the system is capable of forming a transaction for a service offered by a provider between the provider and a customer, the system comprising:
a server having a provider portal and a consumer portal in communication with a database storing information related to the offered service;
the provider portal receiving information from the provider specifying the characteristics of the offered service;
the server storing the offered service in the database; wherein the database comprises a service catalog having the offered service grouped by at least one characteristic of the offered service;
the server displaying the service catalog having the offered service through the consumer portal; and
the server forming a transaction for the offered service upon selection by the consumer, wherein the transaction is based upon characteristics of the offered service.

29. The computer system of claim 28, wherein the offered service is grouped by service category.

30. The computer system of claim 29, wherein the offered service is further grouped by service type.

31. The computer system of claim 28, wherein the information from the provider includes at least one associated service item option for configuring the offered service.

32. The computer system of claim 28, wherein the provider portal and the consumer portal have a web browser-based interface that allows providers and consumers to input characteristics associated with the service.

33. The computer system of claim 28, wherein the server storing the provider information in the database comprises translating the provider information into an extensible markup language.

34. The computer system of claim 33, wherein the extensible markup language is a Service Definition Language.

35. The computer system of claim 33, wherein the Service Definition Language comprises a plurality of properties and translating provider information comprises assigning a value corresponding to the offered service to at least one of the properties.
